(19) United States
(12) Patent Application Publication
(10) Pub. No.: US 2025/0232162 A1
(43) Pub. Date: Jul. 17, 2025

(54) METHOD AND APPARATUS FOR IMPROVED GENERATIVE AI MODELS

(71) Applicant: HUAWEI TECHNOLOGIES CO., LTD., Shenzhen (CN)

(72) Inventors: Parsa Omidi, Markham (CA); Mahsa Salmani, Vaughan (CA); Armaghan Eshaghi, Aurora (CA)

(73) Assignee: HUAWEI TECHNOLOGIES CO., LTD., Shenzhen (CN)

(21) Appl. No.: 18/413,957

(22) Filed: Jan. 16, 2024

(51) Int. Cl. G06N 3/0499; G06F 17/16

(52) U.S. Cl. CPC G06N 3/0499; G06F 17/16

(57) ABSTRACT

There is provided an improved neuron model for spiking neural networks. The neuron model comprises somatic synapses as well as dendritic synapses. The somatic synapses are used for receiving an input token, and the dendritic synapses are used for receiving contextual data. The contextual data is used to modulate the behavior of the spiking neuron. The neuron model may be used to implement an attention mechanism in SSNs and to implement a Mixture-of-Experts architecture.

### OTHER APPLICATIONS

The present application is the first application for this disclosure.

### TECHNICAL FIELD

The present disclosure relates to generative AI models. Specifically, the present disclosure relates to generative AI models integrating dendritic dynamics in spiking neural networks.

### BACKGROUND

Generative Artificial Intelligence (AI) models have recently gained prominence, for example with the advent of ChatGPT. While the potential of such models has become apparent, current models suffer from many drawbacks, including large size (e.g., billions or even trillions of parameters), high computational cost, in both training phase and inference phases, high power consumption, high infrastructure costs, high memory requirements, and high latency, particularly in the inference phase.

### SUMMARY

It is an object of the present disclosure to provide a method for improving the performance of a generative AI model.

In a first aspect, there is provided a method implementing a Spiking Neural Network (SNN) comprising creating at least one layer of spiking neurons, wherein each spiking neuron of the spiking neurons comprises a somatic input of dimensionality d, at least one dendritic input of dimensionality d, and an output of dimensionality d, providing an input token through the somatic input, and providing contextual data through the at least one dendritic input, wherein the output of each of the spiking neurons is modulated by the contextual data.

In a second aspect, there is provided a computing device comprising a processor and memory, wherein the processor and the memory are configured to create at least one layer of spiking neurons, wherein each spiking neuron of the spiking neurons comprises a somatic input of dimensionality d, at least one dendritic input of dimensionality d, and an output of dimensionality d, provide an input token through the somatic input, provide contextual data through the at least one dendritic input, wherein the output of each of the spiking neurons is modulated by the contextual data.

In a third aspect, there is provided a computer readable medium having stored thereon executable code for execution by a processor of a computing device, the executable code comprising instructions for creating at least one layer of spiking neurons, wherein each spiking neuron of the spiking neurons comprises a somatic input of dimensionality d, at least one dendritic input of dimensionality d, and an output of dimensionality d, providing an input token through the somatic input, and providing contextual data through the at least one dendritic input, wherein the output of each of the spiking neurons is modulated by the contextual data.

Specifically, a neural network may be composed of layers of spiking neurons, each spiking neuron having a somatic input of dimensionality d, at least one dendritic input of dimensionality, and an output of dimensionality d. The dimensionality may correspond to an embedding dimensionality. An input token may be provided to the somatic input, and contextual data may be provided through the dendritic input, allowing each neuron to use the contextual data in computing an output.

In at least some implementations of the first aspect, the second aspect, or the third aspect, the at least one dendritic input comprises N basal dendritic inputs and N apical dendritic inputs, and the maximum input sequence length is N.

Dendritic inputs may be separated into apical dendritic inputs and apical dendritic inputs. The number of such inputs may represent a maximum input sequence length.

In at least some implementations of the first aspect, the second aspect, or the third aspect, the contextual data comprises an input sequence.

The input sequence may be provided as contextual data, allowing a neuron to be aware of the entire input sequence.

In at least some implementations of the first aspect, the second aspect, or the third aspect, the input token comprises a Query for a selected token of the input sequence.

The input token may comprise a Query, for example when computing Attention.

In at least some implementations of the first aspect, the second aspect, or the third aspect, the N basal dendritic inputs are configured to receive N Keys, wherein the N apical dendritic inputs are configured to receive N Values, wherein each of the N Keys and each of the N Values are derived from N tokens in the input sequence.

When computing Attention, the Keys and the Values may be provided through dendritic inputs.

In at least some implementations of the first aspect, the second aspect, or the third aspect, the N basal dendritic inputs and the N apical dendritic inputs are shared dendrites whose output is received by each of the spiking neurons.

Some dendritic inputs may be shared by spiking neurons within a layer.

In at least some implementations of the first aspect, the second aspect, or the third aspect, the output of each of the spiking neurons is determined by

$${out}_{i} = \frac{{\sum }_{j = 0}^{N} sim ( {Q}_{i} , {K}_{j} ) {V}_{j}}{{\sum }_{j = 0}^{N} sim ( {Q}_{i} , {K}_{j} )}$$

where outᵢ is the output of neuron i, Qᵢ is the selected Query, Kⱼ and Vⱼ represent the N Keys and the N Values, and sim is a similarity function.

The output of the neuron may be calculated based on the above formula.

In at least some implementations of the first aspect, the second aspect, or the third aspect, the similarity function is one of an exp function and a cosine similarity function.

Different similarity functions may be utilized.

In at least some implementations of the first aspect, the second aspect, or the third aspect, the output of the shared dendrites comprises a scalar determined by:

$${\sum }_{j = 0}^{N} ϕ ( {K}_{j} )$$

and a vector determined by:

$${\sum }_{j = 0}^{N} ϕ ( {K}_{j} ) {V}_{j}$$

where Kⱼ and Vⱼ represent the N Keys and the N Values, and ϕ is a non-negative function of an underlying feature representation.

Shared dendrites may perform calculations for a plurality of neurons, thereby avoiding duplicate computations.

In at least some implementations of the first aspect, the second aspect, or the third aspect, ϕ(x)=elu(x)+1, wherein elu is the exponential linear unit function.

The exponential linear unit function may be used to compute ϕ.

In at least some implementations of the first aspect, the second aspect, or the third aspect, the output of each of the spiking neurons is determined by

$$\frac{S {ϕ ( {Q}_{i} )}^{T}}{{ϕ ( {Q}_{i} )}^{T} V}$$

where S is the scalar and V is the vector.

The spiking neurons may implement an attention mechanism based on the above formula.

### BRIEF DESCRIPTION OF THE DRAWINGS

The present disclosure will be better understood with reference to the drawings in which:

FIG. 1A is a simplified illustration of a pyramidal neuron.

FIG. 1B is an illustration of a point-like neuron model.

FIG. 1C is an illustration of a dendritic neuron model.

FIG. 2 is a graphical representation of an LIF neuron model behavior.

FIG. 3 is a graphical representation of a Spiking Neural Network (SNN).

FIG. 4 is a graphical representation of a dendritic neuron model according to at least some embodiments of the present disclosure.

FIG. 5 is a block diagram of a method of processing attention in an SNN according to at least some embodiments of the present disclosure.

FIG. 6 is a graphical representation of a dendritic neuron model according to at least some embodiments of the present disclosure.

FIG. 7 is a graphical representation of a dendritic neuron model according to at least some embodiments of the present disclosure.

FIG. 8 is a graphical representation of a shared dendrite model according to at least some embodiments of the present disclosure.

FIG. 9 is a graphical representation of a neuron model for using shared dendrites according to at least some embodiments of the present disclosure.

FIG. 10 is a graphical representation of a layer of neurons sharing a dendrite according to at least some embodiments of the present disclosure.

FIG. 11 is a graphical representation of a neural network implementing a Mixture of Experts architecture.

FIG. 12 is a graphical representation of a dendritic SNN architecture for implementing a Mixture of Experts application according to at least some embodiments of the present disclosure.

FIG. 13 is a graphical representation of a neuron model for implementing a Mixture of Experts application according to at least some embodiments of the present disclosure.

FIG. 14 is a block diagram of an exemplary computing device for implementing embodiments of the present disclosure.

### DETAILED DESCRIPTION

The present disclosure is directed to a method and apparatus for improving the efficiency of generative AI models.

Various approaches have been adopted to improve the efficiency and lower the cost of generative AI models:
Optimization approaches: These strategies encompass techniques like model compression and innovative learning techniques. The primary objective is to achieve acceptable performance while using faster and less complex models.
New algorithmic approaches: The original Transformer architecture, built on the attention mechanism, offers powerful capabilities but is constrained by quadratic complexity in memory and computation. As input sequence length increases, the demand for memory and computation increases as well. Innovations such as linear-attention, attention-free, low-rank, and sparse transformers aim to enhance power efficiency by reducing computational loads and memory usage. Although promising, optimal solutions in this area are still under study.
Energy-Efficient Computations—Neuromorphic Computation (NC): This strategy harnesses spiking data representation and processing within Spiking Neural Networks (SNNs). NC holds the promise of energy savings through the use of low-precision data and cost-effective computations but still lags behind conventional deep learning networks such as Artificial Neural Networks (ANNs) in terms of performance. Both the hardware and the software involved in NC are still in experimental stages.

Among these approaches, NC stands out due to its inherent efficiency. NC may also be used in combination with other methods, offering a pathway to optimizing power consumption in large AI models. So far, the only SNN-based language model that has been implemented is SpikeGPT. SpikeGPT, despite its relatively small size (260 million parameters) compared to typical ANN language models (several billions), represents a significant step towards integrating SNN-based generative AI. However, in order to reach comparable performance to that of ANN Transformers, SNN transformers must find a way to scale up.

SpikeGPT can achieve reduction in computation complexity and enhances power efficiency by exploiting the Receptance Weighted Key Value (RWKV) Transformer (an attention-free transformer that scales linearly with input sequence length) and by utilizing binary synaptic operations, thereby significantly reducing computational requirements. This allows SpikeGPT to operate with 22 times fewer synaptic operations, leading to a reduction in power consumption by a factor of 22 when implemented on neuromorphic hardware.

However, SpikeGPT still suffers from many drawbacks, namely:
performance limitations due to i) the approximation of ANN-native backpropagation during training, and ii) using an attention-free Transformer architecture (i.e., RWKV) which results in considerably lower performance than the vanilla attention mechanism;
size limitations compared to typical large models with billions of parameters;
it is not purely based on the same paradigm as SNNs because i) it is more of a quantized version of a Large Language Model (LLM), rather than a spiking version, and ii) it contains Multiply-Accumulate (MAC) computations that are not native to SNNs;
it is not bio-plausible.

Throughout this disclosure, the present terms are given the following definitions.

Generative Artificial Intelligence: Generative AI is a category of deep learning models, specifically designed to generate new content across various domains such as text, audio, and images. Notably, Generative AI models aim to generate data that closely resembles human-created content.

Large Language Models (LLMs): LLMs are a specialized class of generative AI models. They are engineered to understand and generate human-like text by leveraging extensive architectures called Transformers. Notably, ChatGPT exemplifies the application of LLMs. These models excel in processing and interpreting context and semantics within data.

Transformers: Transformers are neural network architectures that utilize a unique processing method called “attention mechanism” to effectively integrate dependencies in sequential data. What sets them apart is their ability to consider the relationship between elements in input or output sequences regardless of their positional distance. Transformers, with their attention mechanism, have revolutionized various natural language processing tasks.

Attention Mechanism: Attention is one component of the Transformer network's architecture, and it is responsible for managing and quantifying the interdependence between the input and output elements (general attention), and within the input elements (self-attention). Attention Mechanism is an attempt to selectively concentrate on fewer relevant things while ignoring other irrelevant things in deep neural networks. It prioritizes and emphasizes relevant information, acting as a spotlight to enhance overall model performance.

Spiking Neural Networks (SNNs): SNNs represent the third generation of deep learning, designed to emulate brain functionality while significantly reducing energy consumption. In SNNs, information transmission and signal processing rely on discrete “spikes,” represented as binary values (0 or 1). This spike-based approach drastically reduces power consumption compared to the continuous value processing employed in ANNs. This power efficiency arises from several factors intrinsic to SNNs, including the utilization of sparse spikes, the transmission of low-precision data, cost-effective computations, and an asynchronous processing model driven by events. In an SNN, a neuron is a fundamental computational unit that mimics a biological neuron in a human brain.

Biological neurons: Biological neurons are the fundamental building blocks of the nervous system in living organisms. They operate by processing information through the generation of discrete electrical pulses, referred to as spikes or action potentials. These spikes play a vital role in encoding and efficiently transmitting data, with their timing and frequency being critical factors. Biological neurons have several key components and characteristics. One important characteristic is the membrane potential that indicates the electrical charge of the neuron's cell membrane. Synapses are neuronal components that act like connections between neurons, to transfer signals. Dendrites are structural branches on the neurons that collect and process incoming signals. Dendrites can play an important role in information integration, computations, and decision-making within neural networks.

Attention mechanisms form the core process of Transformer models. They provide an adaptive weighting based on the dependencies between individual elements (tokens) in sequential data.

ANNs use a conventional attention mechanism (Vanilla Attention), which operates non-parametrically (i.e., no learnable parameters are engaged). It involves three inputs: key (K), value (V), and query (Q). In Vanilla Attention, a dot-product operation between Q and K^{T} (where T is a transpose operation), is followed by a softmax operation to produce an adaptive weight matrix, known as the Attention Map. The Attention Map indicates how much each token is related to the other tokens. The final step involves a matrix multiplication between the Attention Map and V, which results in embedding vectors representing tokens from the input sequence and the relationship to the other tokens in the input sequence.

Specifically, an input sequence comprises tokens, each of which are converted to embedding vectors in a d-dimensional space for processing by a neural network. Typically d is quite large. While such high-dimensional spaces are not easily visualized by a human mind, such spaces have similar mathematical properties to a more familiar three-dimensional space. Accordingly, it is possible to consider that such vectors can be relatively near to each other, or conversely, far from each other.

Prior to the attention mechanism being applied, an input token is embedded to a first vector, as are all other tokens in the input sequence. Then the similarity between the first vector and all other vectors from the input sequence is computed, by computing the Attention Map. When the Attention Map is applied to the first vector, it moves the first vector within the d-dimensional space towards the other vectors in the input sequence in proportion to the similarity between the first vector and the other vectors. In that sense, attention can be thought of as a gravitational pull, where nearer objects exert more pull than far away objects.

Adapting the Vanilla Attention mechanism to SNNs is impractical. SNNs mandate that all data transmitted between memory and processing units be in the form of binary “spikes” (0 or 1). Whereas Vanilla Attention uses dot product operations of matrices with values between 0 and 1, dot product operations of matrices with values of 0 or 1 yield matrices with a very limited number of 1s. Accordingly, there is needed a new representation of data for the attention mechanism that matches with the (spiking) nature of SNNs.

Ideally, SNNs should exhibit two fundamental features: event-driven processing (calculations triggered only when inputs are non-zero) and binary spike communication (data between processing units must be in the format of binary data).

Several approaches have emerged to incorporate spiking neurons into Transformers. The first category, termed “hybrid computing” involves replacing some neurons in the Transformer with spiking neurons to handle various tasks while retaining MAC (Multiply-Accumulate)-required operations like dot-products and softmax. Examples of such works include Zhu et al., SpikeGPT: Generative Pre-trained Language Model with Spiking Neural Networks, arXiv: 2302.13939 [cs.CL], Li et al., Spikeformer: A Novel Architecture for Training High-Performance Low-Latency Spiking Neural Network, arXiv: 2211.10686 [cs.NE], Zhou et al., Spikformer: When spiking neural network meets transformer, International Conference on Learning Representations, 2023 (hereinafter “Zhou et al.”), and Zhou et al., Spikingformer: Spike-driven Residual Learning for Transformer-based Spiking Neural Network, arXiv: 2304.11954 [cs.NE] (hereinafter “Zhou et al. 2”), all of which are incorporated by reference herein.

Notably, Zhou et al. achieves the elimination of MAC operations by removing the softmax operation. This results in large integers in the output, necessitating additional scaling for normalization to mitigate gradient vanishing. Therefore, these approaches often fail to fully exploit energy efficiency and may not be suitable for neuromorphic chips.

Addressing these issues, Yao et al., Spike-driven Transformer, arXiv: 2307.01694 [cs.NE], (hereinafter “Yao et al.”), incorporated herein by reference, proposes two distinct approaches: one utilizes a spiking neuron layer over the Query-Key interaction to generate a binary attention map. The other approach involves Key-Value interaction followed by a spiking neuron layer to produce an adaptive weight vector over the Query. The latter approach leads to a linear attention which is more memory and computational efficient, similar to linear attention in ANNs. Although both these methods are closer to pure SNN models, they still require additional layers of spiking neurons within the attention process. Also, the attention computation is not as intuitive as in Vanilla Attention.

Another innovative SNN-Transformer solution is to employ the attention mechanism on a hidden state level of neurons, such as membrane potential, which is an analog or continuous value, rather than the original binary spike data. Membrane potential, an intrinsic state of spiking neurons, serves as a suitable variable for the attention mechanism. The authors in Yao et al., Attention Spiking Neural Networks, arXiv: 2209.13929 [cs.CV], (hereinafter “Yao et al. 2”), incorporated herein by reference, propose a multi-scale attention mechanism in an SNN model, encompassing temporal, channel, and spatial dimensions to determine ‘when,’ ‘what,’ and ‘where’ to attend, respectively. Channel and spatial attentions operate on the membrane potential of the Leaky Integrate-and-Fire (LIF) neuron models. These internal attentions enhance the processing of relevant information while mitigating interference from distracting noise. Importantly, even though processing attention over membrane potentials involves MAC operations, it significantly increases the sparsity of neuron activity (output spikes) by over 80%, and even results in improved accuracy compared to Vanilla SNN Attention (attention over spike data similar to that of Zhou et al.). By considering both MAC increment and spike count decrement, attention over the membrane state of the neurons produces a greatly enhanced overall energy efficiency.

Scaling language models with more data, computing power, and parameters significantly enhances LLMs' overall performance. However, scaling has become increasingly cost-prohibitive and energy-consuming. Since a substantial portion of the parameters in a transformer architecture belongs to the dense layer (typically comprising 2 layers of neurons after each attention layer), increasing the number of parameters can be achieved by scaling up the size of these layers.

A practical approach to expanding the transformer's size while controlling energy consumption involves sparsifying the model. This means that, for processing a single token, only a fraction of the model becomes activated. This concept aligns with the notion of a Mixture of Experts (MoE), where instead of employing a single large dense layer, multiple smaller dense layers (i.e. “experts”) are used. A router (which usually is another small dense layer) decides which expert/s to activate for each token.

It has been demonstrated by Shen et al., Mixture-of-Experts Meets Instruction Tuning: A Winning Combination for Large Language Models, arXiv: 2305.14705 [cs.CL], incorporated herein by reference, that each expert can learn a unique task during training. This approach allows models to benefit from increased parameter counts while avoiding excessive computational demands.

For instance, Du et al., GLaM: Efficient Scaling of Language Models with Mixture-of-Experts, International Conference on Machine Learning, 2022, incorporated herein by reference, increases the number of parameters to 1.2 trillion but activates only a subnetwork of 96.6 billion (8% of 1.2 trillion) parameters. This is approximately seven times larger than GPT-3, yet it consumes only a third of the energy used to train GPT-3 and requires half the computational flops for the inference phase, with even better performance than GPT-3's. This approach has been integrated into newer language models. However, MoE models pose a significant challenge in terms of memory requirements, limiting the number and size of experts that can be incorporated into the model. More experts may lead to improved performance across a range of tasks but also necessitate storing additional parameters during training and inference phases. Notably, the concept of MoE remains unexplored in SNNs. Nevertheless, it presents an avenue requiring further investigation.

SNNs are known to have issues like gradient vanishing and the emergence of dead neurons, particularly in deeper networks. These problems arise when a neuron fails to receive a sufficient number of spikes at its input to generate any output signal. MoE could serve as a potential remedy in such cases, as it allows for a dynamic allocation of processing resources to address the specific requirements of different tasks or inputs. The flexibility offered by MoE has the potential to mitigate these issues by enabling neurons to contribute meaningfully to the network's overall computations and expanding the model's capacity horizontally, rather than through deepening.

Therefore, changes to attention mechanisms and the adoption of dense layer structures in SNNs represent significant steps within the field of Generative AI. These developments not only expand the capabilities of SNNs but also lay the groundwork for more efficient and powerful neural network models that can excel in complex tasks while conserving computational resources and energy.

Despite these advances, there remains several unaddressed challenges and limitations for integrating SNNs with LLMs:
Maintaining Spike-Based Signaling: One fundamental challenge is the need to preserve all signal transits as spikes throughout the network.
Avoiding MAC Operations: MAC operations are computationally expensive and power-hungry.
Efficiency of Vanilla ANN Attention Mechanism: Maintaining the efficiency and effectiveness of the vanilla ANN Attention mechanism in SNNs is a complex task. The Vanilla ANN Attention differs significantly from the typical SNN computation model.
Scalability with Exploding/Vanishing Gradient and Dead Neuron Challenges: Creating a scalable SNN model that avoids issues such as vanishing/exploding gradients and dead neurons, particularly in deeper networks, remains a significant obstacle.

Among the approaches discussed above, Yao et al. 2 stands out as a promising attempt to address some of these challenges. In order to compute attention, membrane processing appears to have great potentials to reduce power consumption, reduce the number of spikes to transfer, reduce the effect of noisy and/or redundant spikes, and combat vanishing/exploding gradients. The authors propose that using skip connections (residual connections) between membrane potentials instead of spike data can solve the vanishing/exploding gradients issues that are common in SNNs. The membrane residual connections probably allow for network scaling up, approaching the scale of models with billions of parameters to take the benefits of a larger model size. However, it's important to note that Yao et al. 2 introduces a custom-designed attention mechanism that significantly differs from the Vanilla ANN Attention. Furthermore, their approach primarily focuses on self-attention, where input sequences are transformed into output sequences, with each output token being a result of the input token and its dependencies on all other tokens. The attention process in Yao et al. 2 is conducted within the membrane potential space and still involves MAC operations. While their model demonstrates efficiency on GPU processors due to reduced number of spikes, this suggests that it may not be suitable for implementation on neuromorphic chips designed specifically for a predefined neuron model, like LIF neurons (e.g., BrainScaleS, Neurogrid, and TrueNorth). However, neuromorphic chips that permit customization of the neuron model may offer potential compatibility (e.g., SpinNaker and Loihi). These customizable neuromorphic chips operate digitally and, so far, analog neuromorphic chips do not offer configurable neuron models, even though they are known for their energy efficiency. Therefore, to harness the full potential of SNN-LLMs, an ideal scenario would involve an (analog) neuromorphic chip with neurons equipped with an attention mechanism.

The majority of SNN research has concentrated on network architectures and learning mechanisms, keeping a pre-defined neuron model, such as LIF neurons. However, recent research has explored the idea of parametric neuron models, allowing neurons to adapt and specialize based on their unique learning experiences. This approach bears a striking resemblance to the heterogeneous nature of neurons in the brain, where each neuron learns distinct bio-features through its learning journey.

The parametric neuron models in the prior art usually consider bio-features that often revolve around membrane-related characteristics, including the rate of membrane potential leakage over time, the threshold required for a membrane potential to trigger an output spike, and the method by which the membrane potential resets upon spike generation (see Yao et al., Glif: A unified gated leaky integrate-and-fire neuron for spiking neural networks, Advances in Neural Information Processing Systems, 2022, (hereinafter “Yao et al. 3”) and Fang et al., Incorporating learnable membrane time constant to enhance learning of spiking neural networks, Proceedings of the IEEE/CVF international conference on computer vision, 2021), all of which are herein incorporated by reference. Models equipped with learnable parametric neurons have shown faster learning capabilities. In Yao et al. 3, a neuron model is introduced based on LIF with the capacity for each neuron to converge towards a balance between two types of bio-features for leakage, reset, and weighted integration over time steps, facilitating the implementation of time-dependent spike coding schemes like rank-order or phase-order coding.

However, these advancements have omitted two crucial biological aspects. Firstly, the attention mechanism, a behavior that intuitively aligns with neuronal characteristics, has not yet been integrated or proposed as a dynamic aspect of neuron models. While the concept of parametric or gated neuron models enables neurons to acquire specialized characteristics, attention, as a non-parametric process, necessitates the ability to adapt dynamically within the neuron's model. Secondly, all of these works, both in the context of ANNs and SNNs, have considered neurons as point-like models, neglecting the intricate structures of dendrites. Dendrites are complex, offering numerous features that have been validated by neurosciences, yet many aspects remained undiscovered. A comprehensive neuron model must encompass dendritic behavior, offering the potential to introduce “intrinsic attention” into the parametric neuron's model.

The present disclosure provides models which seek to overcome these deficiencies. Specifically, the present disclosure provides models which integrate dendritic dynamics. In some embodiments, the dendritic dynamics are used to implement intrinsic attention within the neuron model.

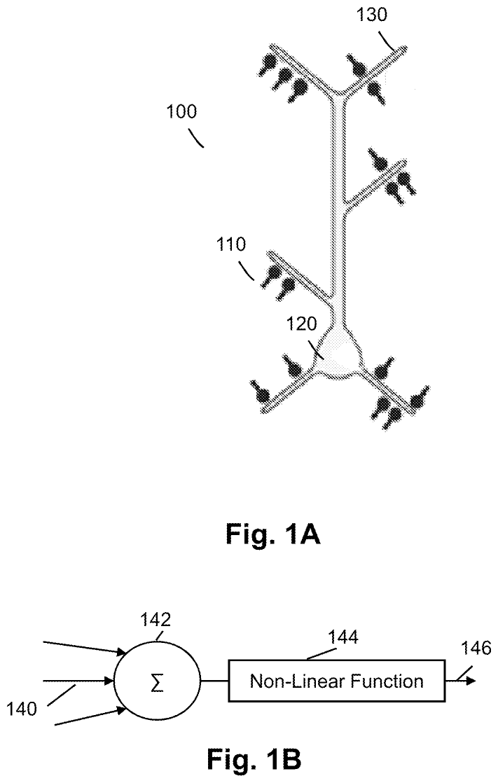

The present disclosure draws inspiration from the intricate neural structures found in biological systems, specifically pyramidal neurons. A pyramidal neuron is illustrated with respect to FIG. 1. As seen in FIG. 1A, a neuron 100 comprises a soma 120. Soma 120 is the central region of the neuron where integration and processing of all received signals takes place. Neuron 100 further comprises synapses 110, which transmit signals between neurons, and dendrites 130, which are responsible for collecting and locally processing incoming signals from synapses.

These neurons are ubiquitous across a wide range of species, and feature various dendrites with unique chemical and morphological characteristics. These dendrites impart several critical advantages to neurons, but are absent in the common neuron models used in both ANNs and SNNs.

Reference is made to FIG. 1B, in which a point-like model of a neuron. As seen in FIG. 1B a neuron 142 receives inputs from synapses 140, and computes a non-linear function 144 for its output 146. Notably, the point-like model of a neuron lacks any dendrites.

In FIG. 1C, a dendritic neuron model, also known as a multi-compartment neuron, is illustrated. As seen in FIG. 1C, the neuron 152 also receives inputs from synapses 150 and computes a non-linear function 154 for its output 156. However, neuron 152 further comprises dendritic dynamic 158, which receives input from dendrites 160, and which themselves receive inputs from dendritic synapses 162. The use of a dendritic neuron model such as the one in FIG. 1C allows to process information from various spatial and temporal sources.

As with conventional point-like neurons, all synapses of a dendritic neuron have plastic connection strength (learnable weights) allowing to weigh different inputs differently, including feed-forward data from somatic synapses and contextual data from dendritic synapses.

Dendritic dynamics introduce essential nonlinearity to neural computations, offering an opportunity for more sophisticated data processing. Dendrites can have active and passive effects on somatic activity, including the ability to control the neurons' hidden states, such as membrane potentials, in linear and non-linear ways. This allows AI model to better capture intricate relationships and patterns within input data.

D-SNNs combine SNNs with dendritic models for additional information integration and non-linearity. SNNs can significantly reduce power consumption due to the nature of sparse spike signals and inexpensive Accumulate (AC) operations. While adding dendrites to the spike neuron model increases the complexity at the neuron level, a neural network with dendritic neurons requires fewer parameters for a specific desired performance. Also, a dendritic model may converge faster and achieve similar or superior performances than non-dendritic models. Increased computational power for individual neurons results in higher energy efficiency for the model.

In comparison to conventional synaptic neurons used in models like SpikeGPT, a D-SNN model introduces more sophisticated computations (additional information integration and non-linearity) to the neurons. The non-linearity of a neuron indicates its capacity to learn non-linear patterns within data. The additional non-linearity empowers neurons to become more proficient at learning complex patterns. Thus, neurons may be modeled to specifically implement intrinsic attention and MoE resembling active dendrites in pyramidal neurons. To achieve this, a new neuron model, termed Leaky Integrate Modulated and Fire (LIMF) is proposed and described below.

SpikeGPT relies on synaptic connections, confronts scalability challenges, and includes the potential for dead neurons in deep networks. Conversely, models based on the present disclosure use localization of dendritic computations to facilitate efficient scaling. The intrinsic modulation mechanism of neurons according to the present disclosure ensures that neurons fire when feedforward input aligns with contextual data, reducing the occurrence of dead neurons.

Contextual data serves as an additional source of information. For instance, for attention purposes, context includes Key-Value pairs, and for MoE, it includes a router that identifies the most suitable expert. Additionally, dendritic models naturally support parallel processing, making them more scalable as the model size increases. This scalability holds promise beyond 1 billion parameters, addressing the limitations faced by SpikeGPT in scaling to larger models.

### Lif Neurons

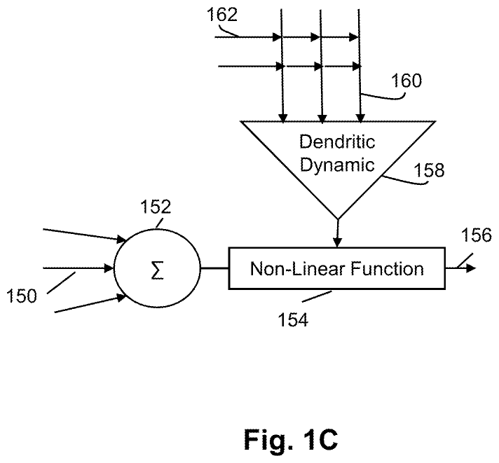

The behavior of an LIF neuron is illustrated with respect to FIG. 2. Specifically, FIG. 2 shows a graph plotting voltage against time. The voltage represents the voltage potential of a neuron's membrane. Generally, when starting at a time T₀, and a voltage V₀, voltage leaks over time, as illustrated by segment 210. The leakage follows a differential equation shown as Equation 1, below, where τ is a constant.

$$τ \frac{dV}{dt} = - V \qquad ( 1 )$$

With every input spike through the neuron's synapses, the membrane potential (or hidden state) of the neuron increases by an amount 220 proportional to the weight of the synapse. In between spikes, the voltage (or hidden state) decays according to Equation 1 again. If the voltage (or hidden state) reaches a threshold voltage 240, the neuron spikes, as shown by segment 230. In some cases, the threshold voltage 240 may be dynamic.

After a spike, the voltage resets to zero, until further spikes are received, at which point the voltage will increase by the amount 220.

The times 260 at which spikes occur may be recorded on a spike train 250. A spike train is a sequence of the timing at which the neurons fired.

### Spiking Neural Networks

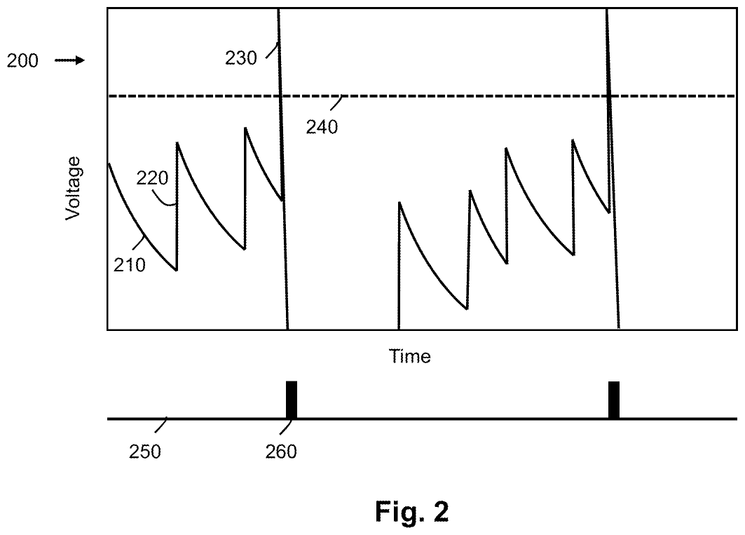

Reference is now made to FIG. 3, in which a basic SNN 300 is illustrated. SNN 300 comprises multiple layers 330, each of the layers 330 being composed of neurons 340. Each neuron of a given layer is connected to all neurons of a subsequent layer through synapses 350.

When an input 310 is received at the input layer (i.e., the leftmost layer in FIG. 3), the input is processed at each neuron 340 of the input layer, and the output of each neuron 340 of the input layer is received at each neuron 340 of the next layer through synapses 350. Synapses 350 may be weighted so that the effect of some neurons on other neurons may be greater than others. Each layer 330 processes the data until the output layer is reached. The output of the output layer is considered the output 320 of SNN 300 for the input 310.

As SNN 300 is a spiking neural network, all data consists of spikes, represented on a spike train as discussed above with respect to FIG. 2. Therefore, the input 310 comprises a spike train, as does the output 320.

Specifically, neurons 340 behave generally as described with respect to FIG. 2. Upon receiving a spike, the hidden state of the neuron increases, whereas between spikes the hidden state of the neuron decays. When the hidden state reaches a threshold, the neuron fires (i.e., sends a spike to the neurons in the next layer).

### Attention Mechanism

The present disclosure provides a novel approach to the attention mechanism which is grounded in the emerging understanding that biological neurons possess intrinsic attention mechanisms, a concept that recently has emerged through collaborative research involving MIT, IBM, and Harvard Medical School. These studies hypothesize the existence of a biological neural network, including neurons and astrocytes (non-neuronal brain cells), with the capability to perform the core computations of a transformer model, i.e., attention mechanism.

The present disclosure leverages the dendritic morphology of pyramidal neurons, driven by the assumption that astrocytes facilitate rapid data communication, enabling the transfer of contextual data between different regions of the brain. This assumption is based on the evidence that mainstream data reaches the somatic synapses of neurons and simultaneously extends to the dendritic components. Dendrites utilize this data to create adaptive weightings (or modulation) for the neuron, effectively implementing an attention mechanism. Moreover, dendrites can retrieve the contextual information from the memory, as shown by Shin et al., Memories off the top of your head, Science, Oct. 28, 2021, Volume 374, Issue 6567, pages 538-539, offering an alternative to mainstream data processing that can be used for the concept of associative memory.

The self-attention mechanism is a fundamental technique in sequence-to-sequence (seq2seq) tasks like machine translation and chatbot applications. It aims to capture token dependencies within a sequence of tokens. Instead of creating a single context, as traditional recurrent neural networks (RNNs) do, attention generates individual contexts for each input token, as shown in Equation 2. In other words, instead of having one overarching context for the entire sequence, the attention mechanism computes a specific context for each token. This context is determined as a weighted combination of all input tokens, with the weights reflecting the importance of each token. Each context Yᵢ is computed as a weighted sum of all input tokens xⱼ:

$${y}_{i} = {\sum }_{j = 0}^{N - 1} {ω}_{ij} {x}_{j} \qquad ( 2 )$$

where yᵢ represents the i-th context token, xⱼ represents all input tokens, and Wᵢⱼ represents the weight (or attention score) for token wj when computing yi. The weights capture the dependencies between specific input tokens i and j, and may be computed using Equation 3 below, which is an expression of the softmax function:

$${ω}_{ij} = \frac{exp ( {{x}_{i}}^{T} {x}_{j} )}{{\sum }_{j = 0}^{N - 1} exp ( {{x}_{i}}^{T} {x}_{j} )} \qquad ( 3 )$$

The above approach to attention has its roots in RNNs where the input sequence comprises hidden states stored in memory.

In some more recent approaches to attention, each token is converted to a Key vector, a Query vector, and a Value vector, by different learned weight matrices. The dot product between a Query vector for a given token and a Key vector for another token produces a value which is proportional to the importance of the relationship between the given token and the other token. This operation for a sequence of tokens may be represented as a matrix multiplication between a Query matrix and a transposed Key matrix, QK^{T}, where Q is the Query matrix where row i comprises the Query vector for token i, and K is the Key matrix, where row j comprises the Key vector for token j. For both the Q and K matrices, the column size is equal to the embedding size (i.e., the vector size). The resulting matrix is an N×N matrix where N is the number of tokens in the input sequence, and which serves as an attention map.

This resulting attention map is then multiplied by a Value matrix, V, where each row i comprises the Value vector for token i, which produces N vectors of the same dimension as the Value vector.

This approach was first published by Vaswani et al., Attention is all you need, Advances in neural information processing systems, 2017, incorporated herein by reference, and can be represented by Equation 4 below, where d is the dimension of the Key vector (i.e., the embedding size):

$$out = Soft max ( \frac{{QK}^{T}}{\sqrt{d}} ) V \qquad ( 4 )$$

According to at least some embodiments of the present disclosure, a neuron model which can intrinsically implement attention is proposed. This neuron model requires multiple inputs, including a single query vector (Q), all key vectors (Ks), and all value vectors (Vs).

To effectively implement the attention mechanism within a dendritic neuron model, Equation 5 may be used:

$${out}_{i} = \frac{{\sum }_{j = 0}^{N - 1} sim ( {Q}_{i} , {K}_{j} ) {V}_{j}}{{\sum }_{j = 0}^{N - 1} sim ( {Q}_{i} , {K}_{j} )} \qquad ( 5 )$$

Equation 5 computes an attention vector outᵢ for token i, where the sim function is a similarity function that may take various forms, such as exp or cosine similarity, amongst others. In order to process attention over hidden states of the spiking neurons, Equation 5 may be modified to Equation 6 as follows:

$${out}_{i} = \frac{{\sum }_{j = 0}^{N - 1} sim ( , {\hat{K}}_{J} ) {\hat{V}}_{J}}{{\sum }_{j = 0}^{N - 1} sim ( , {\hat{K}}_{J} )} \qquad ( 6 )$$

To implement this equation for tokens with embedding sizes of d, d dendritic neurons must be used. Therefore, \hat{Q}ᵢ is a vector of size d, each element of which is a single value representing the hidden state of one of the neuron's soma, \hat{K} has N vectors, each with d dimension for an individual token, representing the dendritic hidden states of the basal dendrites, and \hat{V} has another N vectors, each with d dimension for an individual token, representing the dendritic hidden states of the apical dendrites.

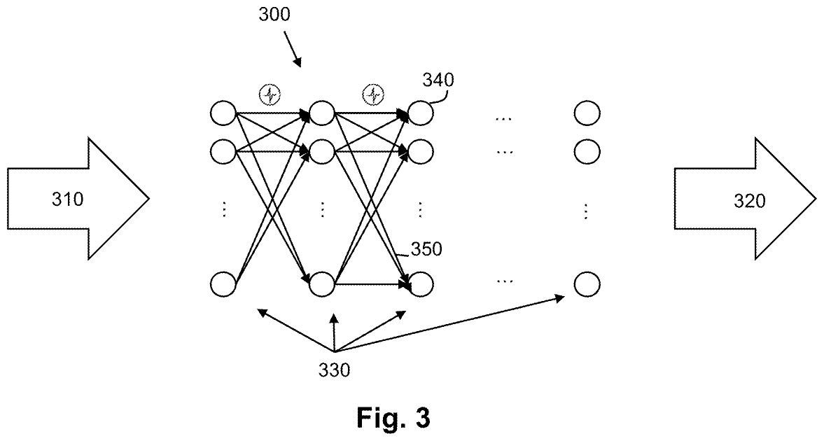

Reference is now made to FIG. 4, in which a pyramidal neuron model according to at least some embodiments of the present disclosure is illustrated.

In FIG. 4, neuron 400 is shown as comprising somatic synapses 410. For example, each of the synapses 410 may receive spikes from neurons of a previous layer. Moreover, each of the synapses 410 may be weighted, so that the hidden state of the neuron 400 is affected differently by spikes from different neurons.

Neuron 400 further comprises basal dendrites 430 and apical dendrites 440, mirroring the structure of biological pyramidal neurons. Basal dendrites 430 and apical dendrites 440 may receive inputs 432 and 442, respectively, in the form of spike trains. Dendritic dynamics 450a and 450b then have an effect on the hidden state of the neuron 400, as described in greater detail below. According to at least some embodiments of the present disclosure, this effect on the hidden state is used to perform attention within the neuron itself.

Specifically, the input 432 received by basal dendrites 430 may comprise the keys Kⱼ for each token in the input sequence, and the input 442 received by apical dendrites 440 may comprise the Values Vⱼ for each token in the input sequence, for j=1 to N, where N is the number of tokens in the input sequence, after being weighted by the corresponding synapses. The embedded token corresponding to the query Qᵢ is received as the feedforward signal from a previous layer via the somatic synapses 410.

As the neuron 400 now has the query Qᵢ and each key Kⱼ and value Vⱼ, it may compute attention for the i-th token in the input sequence within itself, using Equation 6. Specifically, the output 460 of the non-linear function 420 of neuron 400 may be interpreted as the representation of a token from the input sequence, to which attention information has been added. In other words, the output 460 carries information about the i-th token, and information about the relationship between the i-th token and every other token in the input sequence.

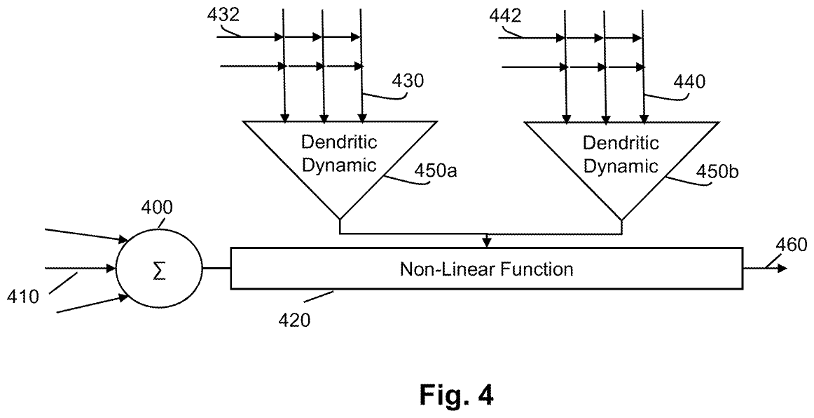

Reference is now made to FIG. 5, in which a method for computing attention according to at least some embodiments of the present disclosure is illustrated.

The method starts at block 500 and proceeds to block 510 in which input tokens are embedded. The input tokens may be received from a user interface, such as a chat bot prompt, as an example, but the present disclosure is not limited in this regard.

Embedding input tokens refers to representing the elements of the input sequence in a format which the neural network can process. For example, in an ANN, tokens are embedded into vectors of real numbers, whereas in an SNN, tokens are embedded into spike trains. Embedding generally requires a trained neural network to produce meaningful values, in the sense that similar input tokens produce similar vectors of real numbers or similar spike trains.

For example, using the example of a chat bot, an input sequence will be a sequence of words, and each word may be viewed as a token. In this case, the embedded values for words like “great” and “awesome” should be similar, because these words have a similar meaning and are used in similar contexts.

For the sake of simplicity, it shall be assumed that the method of FIG. 5 is performed entirely on an SNN. However, this is not necessarily the case and the present disclosure is not limited in that regard. For example, some layers of the neural network may be spiking layers whereas others are not. Assuming a proper interface between spiking layers and non-spiking layers, the present disclosure contemplates the use of any combination of spiking layers and non-spiking layers, with the exception of the attention layer which is performed on an SNN.

Once the tokens are embedded, the method proceeds to block 520 where a single token is fed through somatic synapses to create Qᵢ.

The method then proceeds to block 530 in which each token of the input sequence is fed to the basal synapses and the apical synapses to create Kⱼ and Vⱼ for j=1 to N.

Specifically, according to at least some embodiments of the present disclosure, each dendritic neuron may perform attention for a specific query at a time. Thus, the query Qᵢ for token i is fed trough the dendritic neuron through somatic synapses, the values of K for each token are fed through basal dendrites, and the values of V for each token are fed through apical dendrites. At this stage, as the dendritic neuron is a spiking neuron, data is input as spike trains. Therefore, if the values for Q, K, and V are not already formatted as a spike train, these values are converted to spike trains before being fed into the dendritic neuron.

The output of the dendritic neuron is a vector representing token i, to which the attention map has been applied. This may be conceptualized with an N-dimensional space where all the tokens reside, and where similar tokens are closer to each other and farther away from dissimilar tokens. By applying attention, a token is moved in this N-dimensional space towards the other tokens in the sequence to which it relates the most. The details of how this vector is computed shall be described below.

Based on this output token, the method may proceed to block 540 where further processing occurs. For example, the token may then be passed on to a decoder, where it will be used to produce an output sequence in response to the input sequence, however the present disclosure is not limited in this regard.

The method then proceed to block 550 and ends.

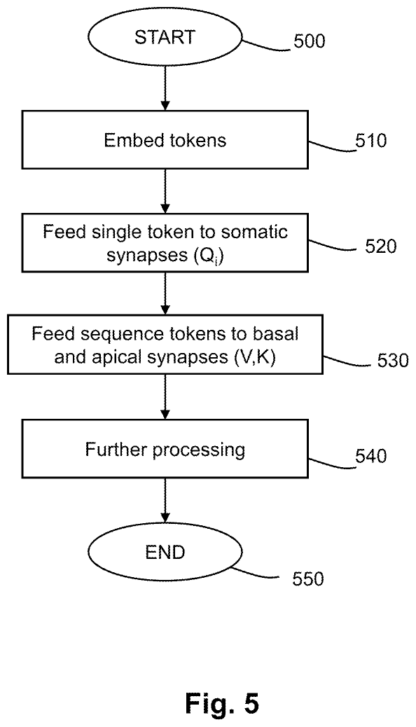

Reference is now made to FIG. 6, which illustrates how dendritic neurons may compute attention for a given query Qᵢ, a series of Keys K, and a series of Values V.

As seen in FIG. 6, neurons 600 comprises a somatic hidden state 610 (\hat{Q}ₜ, in Equation 6), a basal hidden state 620 (\hat{K} in Equation 6), and an apical hidden state 630 (\hat{V} in Equation 6). These hidden states function as the membrane potential described with respect to FIG. 2, such that potential leaks over time. Moreover, as spikes come in through each of somatic synapses 611, basal dendritic synapses 621, and apical dendritic synapses 631, the membrane potential increases.

As discussed above, the Query data may be transmitted through spikes on the somatic synapses 611, the Keys may be transmitted through spikes on basal dendritic synapses 621, and the Values may be transmitted through spikes on apical dendritic synapses 631.

According to at least some embodiments, a given token having an embedding vector of dimension d can be associated to d somatic synapses of the neuron.

In non-spiking neural networks, each token can be represented as a vector of an embedding dimension d. In contrast, in SNNs, data is represented as binary spikes. However, continuous values can be converted into a spike train, also known as a multi-time steps window. As discussed above, a spike train comprises a sequence of times at which a spike occurs.

According to at least some embodiments of the present disclosure, we have d neurons, each comprises d somatic synapses, associated to a d×d matrix of learnable weights, used to process a single token, and two sets of dendrites (basal and apical), each having N dendrites, where N is the length of the input sequence in tokens. Each of the N basal dendrites and each of the N apical dendrites are associated to a d×d matrix of learnable weights. As signals are received through the synapses, each vector of dimension d (namely the single token received through the somatic synapses, the N tokens received through the basal dendrites, and the N tokens received through the apical dendrites) is processed by the corresponding d×d matrix of learnable weights, to produce one vector of dimension d from the somatic hidden state 610, N vectors of dimension d from the basal hidden state 620, and N vectors of dimension d from the apical hidden state 630.

Thus, each of the d somatic synapses 611 influences somatic hidden state 610. Hidden state 610 is also a vector of dimension d.

Basal hidden state 620 is connected to N dendrites, where each dendrite comprises d synapses. Therefore, basal hidden state 620 may be viewed as an N×d matrix, where each row is a vector of dimension d. Apical hidden state 630 is also an N×d matrix, for the same reasons.

At block 650, a similarity function (denoted as ‘SIM’) is performed on the somatic hidden state 610 and each vector from the basal hidden state 620. The somatic hidden state 610 encodes the query, and the basal hidden state 620 encodes all the keys. The similarity function is performed on the query and each key vector, individually, to produce N scalar values.

At block 670, each of the N vectors Vⱼ received from the apical dendritic synapses 631 may be multiplied by the N scalar values. Specifically, for j=1 to N, Vⱼ is multiplied by sⱼ, where sⱼ is a scalar obtained from the similarity function performed on the query and key Kⱼ. This produces N vectors of dimension d, which may be combined together at block 680 to produce a single vector of dimension d.

At block 660, the N scalar values sⱼ are added together. This sum may then be used to divide the vector of dimension d produced at block 680, to produce a normalized vector of dimension d, at block 690.

At block 640, the normalized vector of dimension d may then be output to the next layer. Specifically, the normalized vector of dimension d is converted to a spike train, which is then transmitted through d output synapses.

Accordingly, the neuron 600 of FIG. 6 can implement Equation 6 above, while receiving the data as spikes, and outputting the data as spikes. The output of neuron 600 can be interpreted as a vector representation of a token (Qᵢ) from a sequence, to which attention has been applied.

For an input sequence of length N, an attention layer may comprise N sets of neurons, each set being a combination of d neurons, such as neuron 600 described in FIG. 6. In other words, a neural network comprising an attention layer with N*d neurons may accommodate an input sequence of at most N tokens.

According to at least some embodiment of the present disclosure, a neuron in an SNN may implement Linear Attention with dendritic dynamics, further optimizing the efficiency and adaptability of SNNs for language modeling tasks.

The attention mechanism is a powerful tool for modeling dependencies within sequences. However, its implementation often comes at a high computational cost and involves quadratic memory requirements, which poses scalability and efficiency challenges, in both ANNs and SNNs. To tackle this issue, extensive research within the ANN domain has focused on implementing attention mechanisms using sub-quadratic methods. One such approach is Linear Attention, which endeavors to break down the dot product between the query Q and key K vectors, as proposed in Katharopoulos et al., Transformers are RNNs: Fast autoregressive transformers with linear attention, International conference on machine learning, 2020, incorporated herein by reference.

In this embodiment, the concept of Linear Attention is used to reduce the computational demands of the attention mechanism.

Expanding on Equation 6, and employing a kernel trick, the non-linear similarity function used in Equation 6 and illustrated in FIG. 6 can be replaced with some linear functions. In this context, the kernel, denoted as k(a,b), can be expressed as a non-negative function of an underlying feature representation, ϕ, such that k(a, b)=ϕ(α)^{T}ϕ(b), effectively transforming a non-linear kernel into a linear inner-product operation. The ϕ function encapsulates the essence of the kernel and can have various forms; for instance, ϕ(x)=elu (x)+1, as proposed by Katharopoulos et al, where elu is the exponential linear unit function. Based on this, Equation 6 can be re-written as Equation 7:

$${out}_{i} = \frac{{\sum }_{j = 0}^{N - 1} {ϕ ( {\hat{Q}}_{i} )}^{T} ϕ ( {\hat{K}}_{j} ) {\hat{V}}_{J}^{T}}{{\sum }_{j = 0}^{N - 1} {ϕ ( {\hat{Q}}_{i} )}^{T} ϕ ( {\hat{K}}_{j} )} = \frac{{ϕ ( {\hat{Q}}_{i} )}^{T} {\sum }_{j = 0}^{N - 1} ϕ ( {\hat{K}}_{j} ) {\hat{V}}_{J}^{T}}{{ϕ ( {\hat{Q}}_{i} )}^{T} {\sum }_{j = 0}^{N - 1} ϕ ( {\hat{K}}_{j} )} \qquad ( 7 )$$

In the above, the interaction between \hat{Q} and \hat{K} is decoupled, allowing \hat{Q} to be separated from \hat{K} and \hat{V}. This allows to create a neuron model where the processes of the somatic and dendritic parts are no longer interdependent, as shall be described in detail below.

The dendritic component, which applies a process across the entire sequence, can be executed once and then modulate the process of each neuron's somatic part. This can be thought of as shared dendrites, a phenomenon also observed in biological neurons.

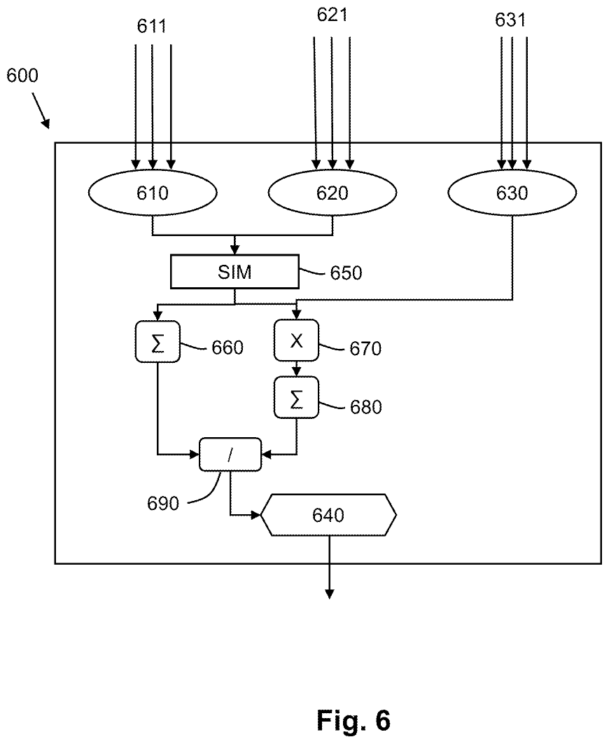

A neuron model implementing Equation 7 is illustrated with respect to FIG. 7.

Specifically, as seen in FIG. 7, a neuron model 700 comprises a somatic hidden state 710, a basal hidden state 720, and an apical hidden state 730. These hidden states function as the membrane potential described with respect to FIG. 2, such that potential leaks over time.

As discussed above, the Query data may be transmitted through spikes on the somatic synapses 711, the Keys may be transmitted through spikes on basal dendritic synapses 721, and the Values may be transmitted through spikes on apical dendritic synapses 731.

At block 750, the Query may be transformed by ϕ. Specifically, ϕ transforms a vector v of dimensionality d into a vector of dimensionality d, ϕ(v). In at least some embodiments, ϕ(x)=elu (x)+1, where elu is the exponential linear unit, although this definition is not restricted to this particular form.

Similarly, at block 752, each Key \hat{K} is transformed by ϕ. The transformed keys ϕ(\hat{K}) are then added up together at block 753. The sum of the transformed keys ϕ(\hat{K}) is then multiplied (for example using dot product) by the transformed Query ϕ(\hat{Q}), to produce a first scalar value, at block 751.

In the example of FIG. 7, each transformed key ϕ(\hat{K}ⱼ) is then multiplied (for example using dot product) with the value \hat{V}ⱼ at block 754, to produce N scalar values which are added together at block 755.

The sum of these N scalar values may then be used to multiply the transformed Query ϕ(\hat{Q}) at block 756, and the scalar value from block 751 is used to divide the resulting vector at block 757. The result of block 757 is then output at block 740.

Therefore, a linear attention mechanism can be implemented on a neuron model as illustrated in FIG. 7.

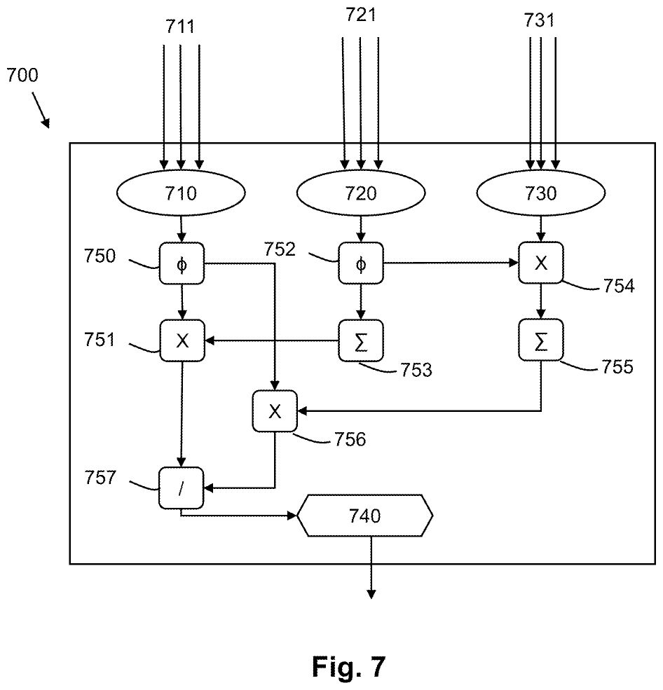

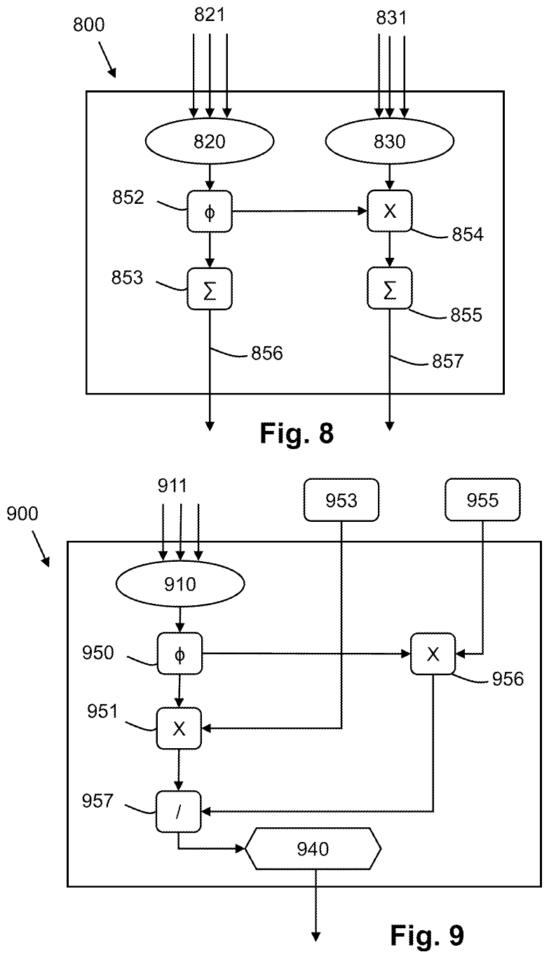

As discussed above, the neuron model of FIG. 7 may also be modified to provide shared dendrites, thereby avoiding the duplication of the same operation, in order to save processing time and resources. A shared dendrite model for implementing Equation 7 is described with respect to FIG. 8 and FIG. 9.

A shared dendrite 800 is illustrated in FIG. 8. Shared dendrite 800 comprises all dendritic elements from the neuron model of FIG. 7.

Specifically, dendrite 800 comprises a basal hidden state 920, and an apical hidden state 830. These hidden states function as the membrane potential described with respect to FIG. 2, such that potential leaks over time.

As discussed above, the Keys may be transmitted through spikes on basal dendritic synapses 821, and the Values may be transmitted through spikes on apical dendritic synapses 831. For example, basal dendritic synapses 821 may receive N 1×d vectors, where each 1×d vector corresponds to a Key. Similarly, apical dendritic synapses 831 may receive N 1×d vectors, where each 1×d vector corresponds to a Value.

Each of the N basal dendrites and each of the N apical dendrites are associated to a d×d matrix of learnable weights. The received inputs are transformed through the learnable weights in d×d matrices, such that a received 1×d vector is multiplied by its corresponding d×d weight matrix, to produce a 1×d vector for each of the N 1×d vectors.

At block 852, each of the N Keys \hat{K} is transformed by ϕ to produce an N×d matrix (N vectors of dimension d). The transformed keys ϕ(\hat{K}) may then be added up together at block 853. The vector of dimension d representing the sum of the transformed Keys ϕ(\hat{K}) may then be output at 856 for neurons to use.

In the example of FIG. 8, each transformed key ϕ(\hat{K}ⱼ) is then multiplied (for example using dot product) by a corresponding vector \hat{V}ⱼ, for j=1 to N, at block 854. This produces N scalar values, which may be added together at block 855 to produce a scalar value that is output at 857 for neurons to use.

Specifically, a plurality of neurons may be connected to dendrite 800 to receive outputs 856 and 857. Because the values for outputs 856 and 857 can be calculated only once for a plurality of neurons, greater efficiency is achieved.

One such neuron is illustrated at FIG. 9. Specifically, the neuron of FIG. 9 comprises the somatic elements from the neuron of FIG. 7, and may also receive inputs from a dendrite such as dendrite 800 from FIG. 8.

As seen in FIG. 9, neuron 900 comprises a somatic hidden state 910. This hidden state functions as the membrane potential described with respect to FIG. 2, such that potential leaks over time.

As discussed above, the Query data may be transmitted through spikes on the somatic synapses 911. Specifically, each Query of the N queries Qᵢ for i=1 to N may be transmitted to its own neuron 900. A d×d matrix of learnable weights may be used to receive the Query as discussed above with respect to FIG. 6. The contextual information from the entire input sequence is provided from a shared dendrite such as the dendrite 800 from FIG. 8. Specifically, the contextual information may comprise outputs 856 and 857 from a shared dendrite 800.

At block 950, the hidden state of the Query [symbol] may be transformed by ϕ to produce ϕ( [symbol] ). The sum of the transformed keys ϕ(\hat{K}) is received via input 953 from a shared dendrite, and is multiplied (for example using dot product) by the transformed Query ϕ( [symbol] ), to produce a first scalar value, at block 951.

The sum of the N scalar values from multiplying keys \hat{K}ⱼ with values \hat{V}ⱼ is received via input 955 from a shared dendrite, and may be used to multiply the transformed Query ϕ( [symbol] ) at block 956. In the example of FIG. 9, the first scalar value from block 951 is then used to divide the resulting vector at block 957. The result of block 957, which is a vector of dimension d, is then output at block 940.

FIG. 9 illustrates the LIMF neuron model, an extension of the LIF neuron model that incorporates two additional modulation inputs, denoted as 953 and 955.

Therefore, a linear attention mechanism can be implemented on a neuron model and a shared dendrite model, as illustrated in FIG. 8 and in FIG. 9.

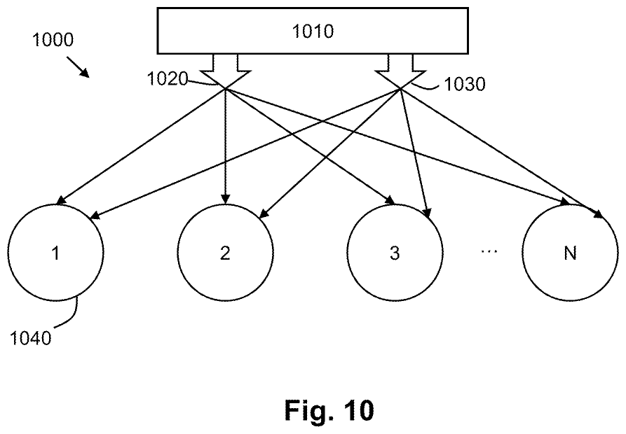

FIG. 10 illustrates a layer of neurons such as the neuron illustrated in FIG. 9 sharing a dendrite such as the dendrite illustrated in FIG. 8.

Specifically, as seen in FIG. 10, a spiking neural network 1000 is shown. The SNN 1000 comprises a shared dendrite 1010, and N neurons 1 to N, 1040. Shared dendrite 1010 receives contextual information in the form of the keys and values for each token in the input sequence, and performs the operations discussed above to produce outputs 1020 and 1030. These outputs correspond to outputs 856 and 857 from FIG. 8.

Outputs 1020 and 1030 are connected to each neuron 1040, so that the computations needed to produce the values from these outputs is only performed once. Each neuron 1040 receives a corresponding query Qᵢ through its membrane potential. The neuron may then perform the computations described with respect to FIG. 9, to produce their respective output, which may be interpreted as a representation of the i-th token from a sequence to which linear attention has been applied.

### Mixture of Experts (Moe)

According to at least some embodiments of the present disclosure, a dendritic neuron model is used to implement an MoE architecture. An MoE architecture in a neural network conventionally comprises a routing layer, whose purpose it is to select an expert sub-network to perform a specific task.

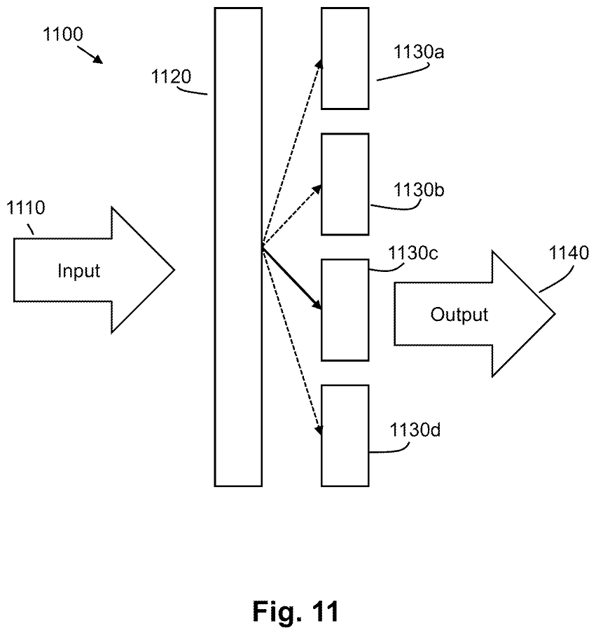

Reference is made to FIG. 11, which illustrates a conventional MoE architecture using a neural network. As seen in FIG. 11, a neural network 1100 comprises a routing layer 1120 and a plurality of expert sub-layers 1130a, 1130b, 1130c, and 1130d. Although FIG. 11 only comprises 4 expert sub-layers, this is not intended to be limiting and is shown for illustrative purposes only.

As an input token 1110 is received by the routing layer 1120, the routing layer selects one of the expert sub-layers to process the input token. Specifically, routing layer has been trained to select a suitable expert based on training data, such that as input token 1110 is received, the most suitable expert for processing input token 1110 is selected by routing layer 1120. In the example of FIG. 11, expert sub-layer 1130c is selected, and so expert sub-layer 1130c processes the input token 1110 to produce output token 1140.

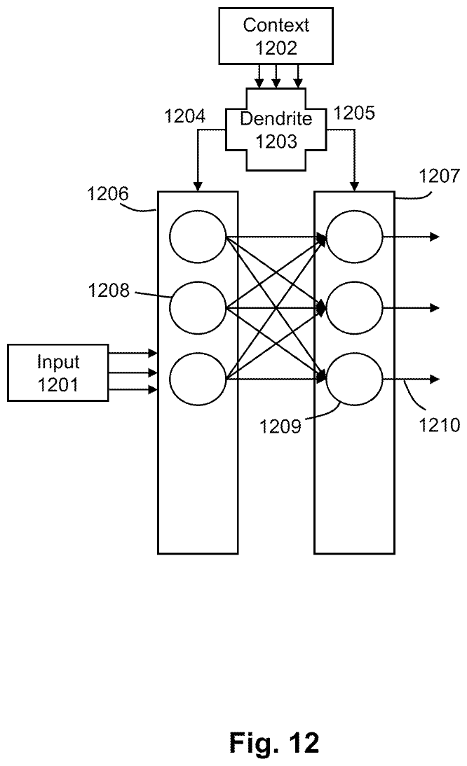

Reference is now made to FIG. 12, which illustrates an MoE architecture in an SNN according to at least some embodiments of the present disclosure.

As seen in FIG. 12, an SNN comprises a first layer 1206 comprising F LIMF neurons 1208 with a shared dendritic input 1203, and a second layer 1207 comprising d LIMF neurons 1209, also sharing dendritic input 1203.

Dendritic input 1203 may comprise a dendrite with d synapses for receiving contextual data. For example, the contextual data may comprise one token of dimensionality d, which d is the embedding dimension.

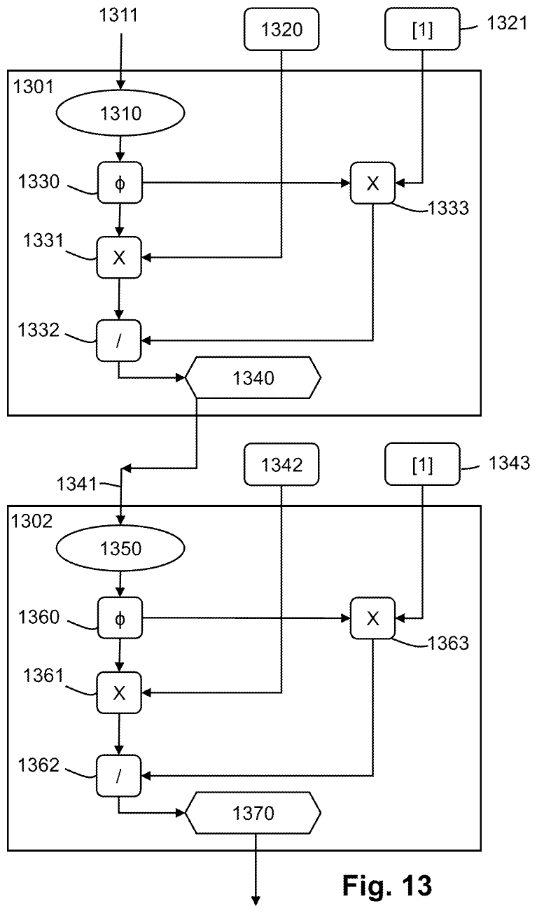

According to at least one embodiment, dendritic input 1203 is composed of two parts, which may be combined as they both use the same input data, namely a token of dimensionality d representing contextual data. In a first part, the contextual data is processed by M d×F matrices of learnable weights, where M is the number of experts for the MoE architecture, and F is the number of neurons in first layer 1206. The contextual data may be processed by each of the M d×F matrices to produce M vectors of dimensionality F. One of the M vectors of dimensionality F is then selected by a selection function. In one embodiment, the selection function may be a k-Winners-take-all (KWTA) function to select k experts, or k=1 to select one expert. Alternatively, the selection function may select the vector with the greatest amplitude (i.e., a max function). The selected vector is then output from dendrite 1203 and provided as input 1204 to first layer 1206 as contextual data. The processing of the contextual data by first layer 1206 is described below with respect to FIG. 13.

In a second part of dendritic input 1203, the contextual data is processed by M d×d matrices of learnable weights, where M is the number of experts for the MoE architecture, to produce M d-dimensional vectors. One of the M d-dimensional vectors is then selected by a selection function such as a KWTA or a max function, and output from dendrite 1203 and provided as input 1205 to second layer 1207 as contextual data. The processing of this contextual data by second layer 1207 is described below with respect to FIG. 13.

Neurons 1208 from first layer 1206 further receive input token 1201 through their respective somatic synapses. Neurons 1208 of first layer 1206 each output a single spike event, which is provided to each neuron 1209 of second layer 1207, thereby providing an F-dimensional vector as input to each neuron 1209. Similarly, neurons 1209 of second layer 1207 each output 1210, thereby providing a d-dimensional vector as output of the MoE architecture.

Reference is now made to FIG. 13, in which the processing by the first layer and the second layer of FIG. 12 is described in detail.

An input token, corresponding to input 1201 of FIG. 12, may be provided through somatic synapses 1311 of first layer 1301. The input token has a dimensionality d, and is received through hidden state 1310. A d×F matrix of learnable weights may be applied to the input token to create an F-dimensional vector α.

Contextual input 1320 receives the F-dimensional vector β selected by a dendrite such as input 1204 from dendrite 1203 of FIG. 12. Specifically, as there are F neurons in the first layer, each element of the F-dimensional vector may be provided to a separate neuron of the first layer.

Contextual input 1321 may be provided with a vector with all elements being equal to 1. This allows to essentially turn off some functionality of the neuron model and make it suitable for an MoE application.

The F-dimensional vector α received from somatic synapses 1311 may then be processed at block 1330 to compute ϕ(α). At block 1331, ϕ(α) is multiplied by β to produce a scalar value γ, and at block 1333, ϕ(α) is multiplied by a vector of 1s, and remains unchanged. Then, at block 1332, ϕ(α) is divided by γ, to produce an F-dimensional vector which is output by the first layer 1301 at 1340.

The process then moves on to a second layer 1302, in which the output of 1340 is fed in through somatic synapses 1341 to hidden state 1350 through an F×d matrix of learnable weights to create a d-dimensional vector α₂. Contextual input 1342 receives the d-dimensional vector β₂ selected by a dendrite such as input 1205 from dendrite 1203 of FIG. 12.

The d-dimensional vector α₂ received from somatic synapses 1341 may then be processed at block 1360 to compute ϕ(α₂). At block 1361, ¢ (α₂) is multiplied by β₂ to produce a scalar value γ₂, and at block 1363, ϕ(α₂) is multiplied by a vector of 1s, and remains unchanged. Then, at block 1362, ϕ(α₂) is divided by γ, to produce a d-dimensional vector which is output by the second layer 1302 at 1370. Output 1370 represents the output for the MoE architecture.

Accordingly, a Mixture of Experts (MoE) architecture may be implemented on an SNN based on the above.

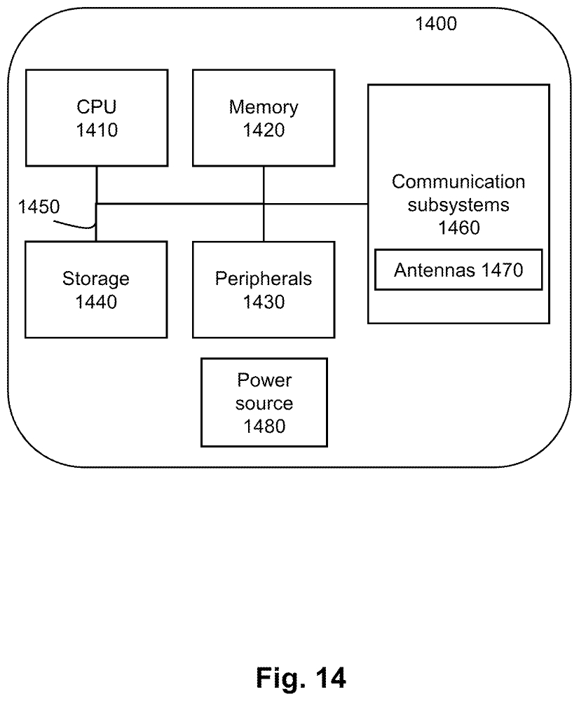

The above functionality may be implemented on any one or combination of computing devices. FIG. 14 is a block diagram of a computing device 1400 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 1400 may comprise a central processing unit (CPU) 1410, memory 1420, a mass storage device 1440, and peripherals 1430. Peripherals 1430 may comprise, amongst others one or more input/output devices, such as a speaker, microphone, mouse, touchscreen, keypad, keyboard, printer, display, network interfaces, and the like. Communications between CPU 1410, memory 1420, mass storage device 1440, and peripherals 1430 may occur through one or more buses 1450.

The bus 1450 may be one or more of any type of several bus architectures including a memory bus or memory controller, a peripheral bus, video bus, or the like. The CPU 1410 may comprise any type of electronic data processor. The memory 1420 may comprise any type of system memory such as static random-access memory (SRAM), dynamic random-access memory (DRAM), synchronous DRAM (SDRAM), read-only memory (ROM), a combination thereof, or the like. In an embodiment, the memory 1420 may include ROM for use at boot-up, and DRAM for program and data storage for use while executing programs.

The mass storage device 1440 may comprise any type of storage device configured to store data, programs, and other information and to make the data, programs, and other information accessible via the bus. The mass storage device 1440 may comprise, for example, one or more of a solid-state drive, hard disk drive, a magnetic disk drive, an optical disk drive, or the like.

The computing device 1400 may also include one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network, for data processing and communications with remote devices, such as other processing units, the Internet, remote storage facilities, or the like.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

In particular, example clauses may include:
A. A method for implementing a Spiking Neural Network, comprising creating at least one layer of spiking neurons, wherein each spiking neuron of the spiking neurons comprises: a somatic input of dimensionality d; at least one dendritic input of dimensionality d; and an output of dimensionality d; providing an input token through the somatic input; and providing contextual data through the at least one dendritic input; wherein the output of each of the spiking neurons is modulated by the contextual data.
B. The method of clause A, wherein the contextual data causes the spiking neurons to perform a first task for a first category of contextual data, and wherein the contextual data causes the spiking neurons to perform a second task for a second category of contextual data.
C. The method of clause B, wherein the contextual data comprises an input sequence.
D. The method of clause B, wherein the contextual data comprises a category of the input sequence.
E. The method of clause D, further comprising pre-processing the input sequence with a preceding layer to compute the category of the input sequence.
F. The method of clause B, wherein the at least one dendritic input are shared dendrites whose output is received by each of the spiking neurons.
G. A computing device for implementing a Spiking Neural Network, comprising a processor; and memory; wherein the processor and the memory are configured to: create at least one layer of spiking neurons, wherein each spiking neuron of the spiking neurons comprises: a somatic input of dimensionality d; at least one dendritic input of dimensionality d; and an output of dimensionality d; provide an input token through the somatic input; and provide contextual data through the at least one dendritic input; wherein the output of each of the spiking neurons is modulated by the contextual data.
H. The computing device of clause G, wherein the contextual data causes the spiking neurons to perform a first task for a first category of contextual data, and wherein the contextual data causes the spiking neurons to perform a second task for a second category of contextual data.
I. The computing device of clause H, wherein the contextual data comprises an input sequence.
J. The computing device of clause H, wherein the contextual data comprises a category of the input sequence.
K. The computing device of clause J, wherein the processor and the memory are further configured to pre-process the input sequence with a preceding layer to compute the category of the input sequence.
L. The computing device of clause H, wherein the at least one dendritic input are shared dendrites whose output is received by each of the spiking neurons.
M. A computer readable medium having stored thereon executable code for execution by a processor of a computing device, the executable code comprising instructions for: creating at least one layer of spiking neurons, wherein each spiking neuron of the spiking neurons comprises: a somatic input of dimensionality d; at least one dendritic input of dimensionality d; and an output of dimensionality d; providing an input token through the somatic input; and providing contextual data through the at least one dendritic input; wherein the output of each of the spiking neurons is modulated by the contextual data.
N. The computer readable medium of clause M, wherein the contextual data causes the spiking neurons to perform a first task for a first category of contextual data, and wherein the contextual data causes the spiking neurons to perform a second task for a second category of contextual data.
O. The computer readable medium of clause N, wherein the contextual data comprises an input sequence.
P. The computer readable medium of clause N, wherein the contextual data comprises a category of the input sequence.
Q. The computer readable medium of clause P, wherein the executable code further comprises instructions for pre-processing the input sequence with a preceding layer to compute the category of the input sequence.
R. The computer readable medium of clause N, wherein the at least one dendritic input are shared dendrites whose output is received by each of the spiking neurons.

1. A method for implementing a Spiking Neural Network (SNN) comprising:
creating at least one layer of spiking neurons, wherein each spiking neuron of the spiking neurons comprises:
a somatic input of dimensionality d;
at least one dendritic input of dimensionality d; and
an output of dimensionality d;
providing an input token through the somatic input; and
providing contextual data through the at least one dendritic input;
wherein the output of each of the spiking neurons is modulated by the contextual data.

2. The method of claim 1, wherein the at least one dendritic input comprises N basal dendritic inputs and N apical dendritic inputs, and wherein a maximum input sequence length is N.

3. The method of claim 2, wherein the contextual data comprises an input sequence.

4. The method of claim 3, wherein the input token comprises a Query for a selected token of the input sequence.

5. The method of claim 4, wherein the N basal dendritic inputs are configured to receive N Keys, wherein the N apical dendritic inputs are configured to receive N Values, wherein each of the N Keys and each of the N Values are derived from N tokens in the input sequence.

6. The method of claim 5, wherein the N basal dendritic inputs and the N apical dendritic inputs are shared dendrites whose output is received by each of the spiking neurons.

7. The method of claim 5, wherein the output of each of the spiking neurons is determined by
$${out}_{i} = \frac{{\sum }_{j = 0}^{N} sim ( {Q}_{i} , {K}_{j} ) {V}_{j}}{{\sum }_{j = 0}^{N} sim ( {Q}_{i} , {K}_{j} )}$$
where outᵢ is the output of neuron i, Qᵢ is the selected Query, Kⱼ and Vⱼ represent the N Keys and the N Values, and sim is a similarity function.

8. The method of claim 7, wherein the similarity function is one of an exp function and a cosine similarity function.

9. The method of claim 6, wherein the output of the shared dendrites comprises a scalar determined by:
$${\sum }_{j = 0}^{N} ϕ ( {K}_{j} )$$
and a vector determined by:
$${\sum }_{j = 0}^{N} ϕ ( {K}_{j} ) {V}_{j}$$
where Kⱼ and Vⱼ represent the N Keys and the N Values, and ϕ is a non-negative function of an underlying feature representation.

10. The method of claim 9, wherein ϕ(x)=elu (x)+1, wherein elu is the exponential linear unit function.

11. The method of claim 10, wherein the output of each of the spiking neurons is determined by:
$$\frac{S {ϕ ( {Q}_{i} )}^{T}}{{ϕ ( {Q}_{i} )}^{T} V}$$
where S is the scalar and V is the vector.

12. A computing device comprising:
a processor; and
memory;
wherein the processor and the memory are configured to:
create at least one layer of spiking neurons, wherein each spiking neuron of the spiking neurons comprises:
a somatic input of dimensionality d;
at least one dendritic input of dimensionality d; and
an output of dimensionality d;
provide an input token through the somatic input; and
provide contextual data through the at least one dendritic input;
wherein the output of each of the spiking neurons is modulated by the contextual data.

13. The computing device of claim 12, wherein the at least one dendritic input comprises N basal dendritic inputs and N apical dendritic inputs, and wherein the maximum input sequence length is N.

14. The computing device of claim 13, wherein the contextual data comprises an input sequence.

15. The computing device of claim 14, wherein the input token comprises a Query for a selected token of the input sequence.

16. The computing device of claim 15, wherein the N basal dendritic inputs are configured to receive N Keys, wherein the N apical dendritic inputs are configured to receive N Values, wherein each of the N Keys and each of the N Values are derived from N tokens in the input sequence.

17. The computing device of claim 16, wherein the N basal dendritic inputs and the N apical dendritic inputs are shared dendrites whose output is received by each of the spiking neurons.

18. The computing device of claim 17, wherein the output of the shared dendrites comprises a scalar determined by:
$${\sum }_{j = 0}^{N} ϕ ( {K}_{j} )$$
and a vector determined by:
$${\sum }_{j = 0}^{N} ϕ ( {K}_{j} ) {V}_{j}$$
where Kⱼ and Vⱼ represent the N Keys and the N Values, and ϕ is a non-negative function of an underlying feature representation, wherein elu is an exponential linear unit function.

19. The method of claim 18, wherein the output of each of the spiking neurons is determined by:
$$\frac{S {ϕ ( {Q}_{i} )}^{T}}{{ϕ ( {Q}_{i} )}^{T} V}$$
where S is the scalar and V is the vector.

20. A computer readable medium having stored thereon executable code for execution by a processor of a computing device, the executable code comprising instructions for:
creating at least one layer of spiking neurons, wherein each spiking neuron of the spiking neurons comprises:
a somatic input of dimensionality d;
at least one dendritic input of dimensionality d; and
an output of dimensionality d;
providing an input token through the somatic input; and
providing contextual data through the at least one dendritic input;
wherein the output of each of the spiking neurons is modulated by the contextual data.
